(19) United States
(12) Patent Application Publication
(10) Pub. No.: US 2013/0188367 A1
(43) Pub. Date: Jul. 25, 2013

(54) LIGHTING STRUCTURE AND FIXING BASE THEREOF

(71) Applicants: Shun-Ho Wu, Kaohsiung City (TW); Chih-Cheng Huang, Kaohsiung City (TW)

(72) Inventors: Shun-Ho Wu, Kaohsiung City (TW); Chih-Cheng Huang, Kaohsiung City (TW)

(73) Assignee: TAIWAN FU HSING INDUSTRIAL CO., LTD., Kaohsiung City (TW)

(21) Appl. No.: 13/407,998

(22) Filed: Feb. 29, 2012

(30) Foreign Application Priority Data
Jan. 20, 2012 (TW) 101102585

(51) Int. Cl. F21V 15/01

(52) U.S. Cl. 362/362

(57) ABSTRACT

A lighting structure comprises a case, a fixing base, a substrate and a lighting device. The fixing base disposed at the case comprises a bearing plate and a plurality of fixing plates, wherein the substrate is disposed at the bearing plate, and the fixing plates are bendable to form a clip space between the fixing plates and the bearing plate. The substrate is limited within the clip space and clipped by the bearing plate and the fixing plates. In addition, the case further comprises an accommodating chamber and at least one combining portion, when the fixing base is disposed at an opening of the case, the at least one combining portion is bendable toward the accommodating chamber and clips the fixing base.

### FIELD OF THE INVENTION

The present invention is generally related to a lighting structure, which particularly relates to a fixing base and a substrate of the lighting structure that are stably clipped.

### BACKGROUND OF THE INVENTION

A conventional lighting structure 10 in accordance with FIG. 14 includes a case 11, a base 12, a lighting module 13 and a lamp cover 14, wherein the lighting module 13 is disposed at the base 12. However, for the reason that the base 12 is restrained between the case 11 and the lamp cover 14 without using any screws, threads, or glues, the base 12 may be likely fallen off in the process of moving the lighting structure 10 so that the lighting module 13 disposed at the base 12 will be easily damaged.

Besides, an LED heat-dissipation structure as disclosed in Taiwan patent number M419877 mainly utilizes screws to secure a heat-conductive plate and a circuit board. The way to secure by using screws may lead a prepared material problem. With increasing of quantity of the screws, a longer time for securing is required, which results a low assembly-efficiency for the LED heat-dissipation structure.

### SUMMARY

The primary object of the present invention is to provide a lighting structure. A plurality of fixing plates of a fixing base is bendable to make a substrate clipped between a bearing plate of the fixing base and the fixing plates. The substrate is fixed at the fixing base to prevent the substrate from falling off while moving the lighting structure.

The lighting structure in this invention comprises a case, a fixing base, a substrate and a lighting device. The lighting device is disposed at the substrate, and the fixing base disposed at the case includes a bearing plate and a plurality of fixing plates. The bearing plate comprises a bearing surface, the fixing plates are coupled to the bearing plate, and at least part of each of the fixing plates is spaced from the bearing surface. The fixing plates are bendable to form a clip space between the bearing plate and each of the fixing plates. The substrate is disposed on the bearing surface of the bearing plate, the substrate is clipped by the bearing plate and the fixing plates, and the substrate is limited within the clip space.

### DESCRIPTION OF THE DRAWINGS

FIG. 1 is a perspective exploded view illustrating a lighting structure in accordance with a first embodiment of the present invention.

FIG. 2 is a lateral view illustrating a fixing base of the lighting structure in accordance with a first embodiment of the present invention.

FIG. 3 is a partially perspective exploded view illustrating a lighting structure in accordance with a first embodiment of the present invention.

FIG. 4 is a lateral view illustrating the lighting structure with a first embodiment of the present invention.

FIG. 5 is a top view illustrating the lighting structure in accordance with a first embodiment of the present invention.

FIG. 6 is a perspective exploded diagram illustrating a lighting structure in accordance with a second embodiment of the present invention.

FIG. 7 is a partially perspective assembly diagram illustrating the lighting structure in accordance with a second embodiment of the present invention.

FIG. 8 is a partially section view illustrating the lighting structure in accordance with a second embodiment of the present invention.

FIG. 9 is a partially section view illustrating the lighting structure in accordance with a second embodiment of the present invention.

FIG. 10 is a partially section view illustrating the lighting structure in accordance with a second embodiment of the present invention.

FIG. 11 is a lateral view illustrating a case of the lighting structure in accordance with a second embodiment of the present invention.

FIG. 12 is a top view illustrating the case of the lighting structure in accordance with a second embodiment of the present invention.

FIG. 13 is a bottom view illustrating the case of the lighting structure in accordance with a second embodiment of the present invention.

FIG. 14 is a section view of a conventional lighting structure.

### DETAILED DESCRIPTION OF THE INVENTION

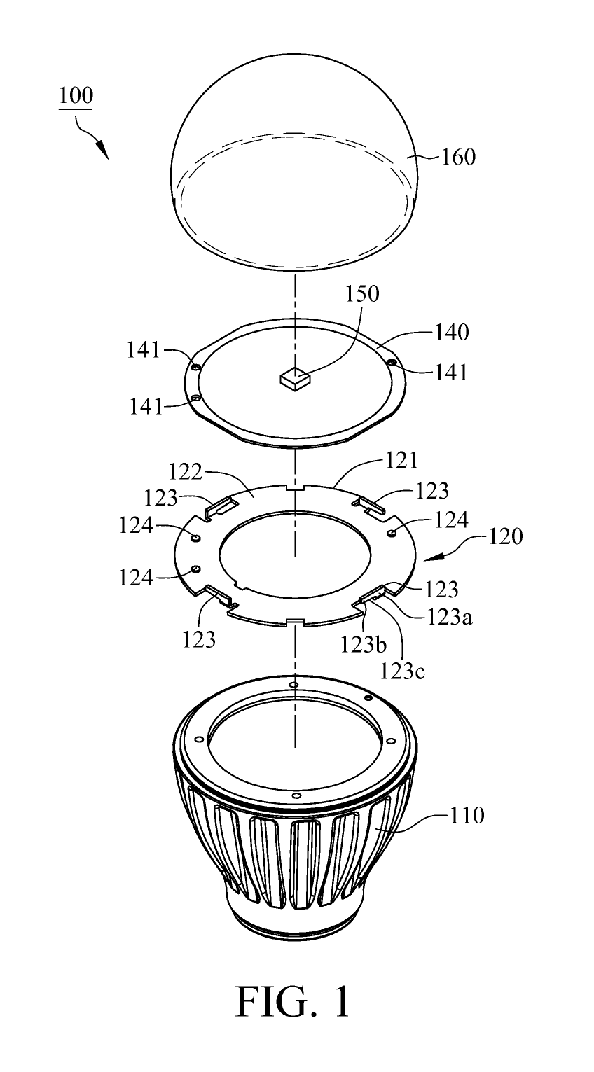

With reference to FIG. 1, a lighting structure 100 in accordance with a first embodiment of the present invention comprises a case 110, a fixing base 120, a substrate 140, a lighting device 150 and a lamp cover 160. The substrate 140 and the lighting device 150 can be a lighting module, and the lighting device 150 is disposed at the substrate 140. In this embodiment, the fixing base 120 can be a metal plate and includes a bearing plate 121 and a plurality of fixing plates 123. The bearing plate 121 and the fixing plates 123 are formed by process of stamping. The bearing plate 121 comprises a bearing surface 122, the fixing plates 123 coupled to the bearing plate 121 are bendable upwardly, and at least part of each of the fixing plates 123 is located on the bearing surface 122. The fixing plate 123 includes a body portion 123a and a bending portion 123b, wherein the body portion 123a is coupled to the bearing plate 123.

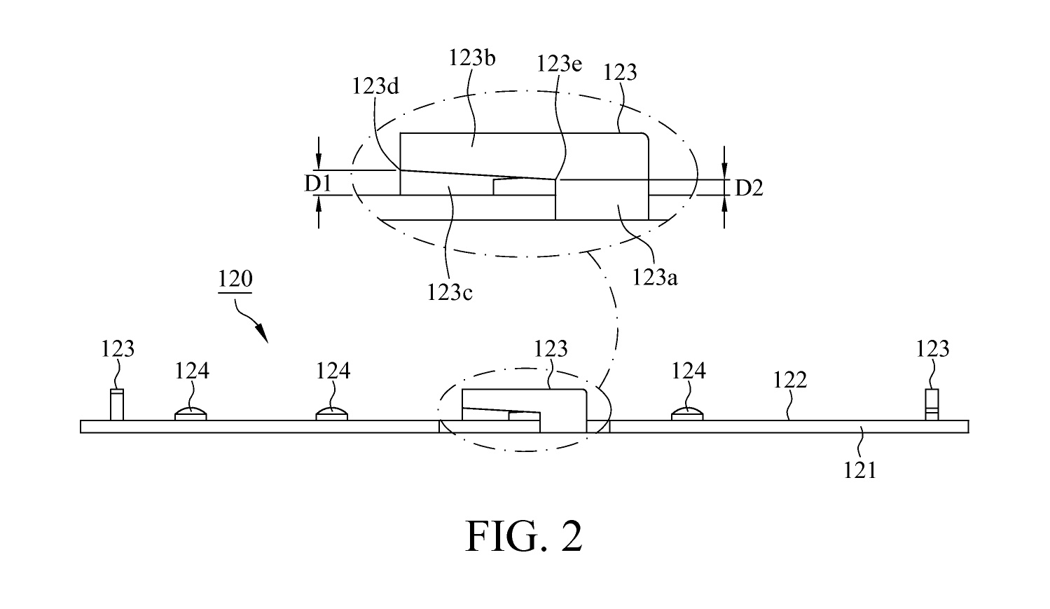

Referring to FIGS. 1 and 2, the bending portion 123b comprises a gap 123c having a front edge 123d and a rear edge 123e, a first interval D1 is formed between the front edge 123d and the bearing surface 122, a second interval D2 is formed between the rear edge 123e and the bearing surface 122, and the first interval D1 is larger than the second interval D2.

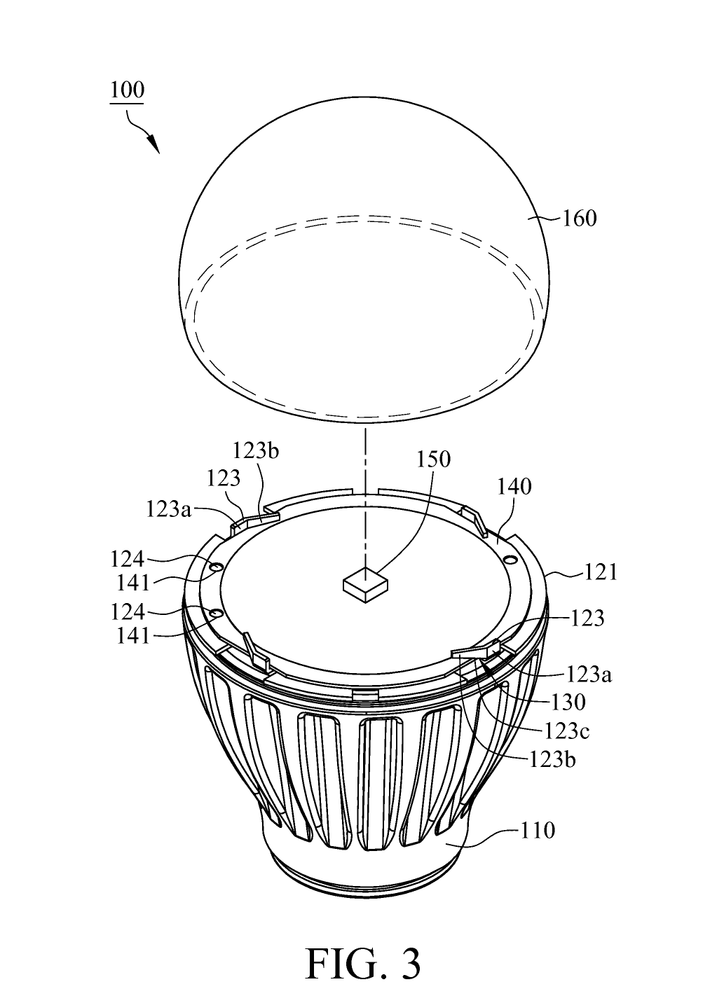

With reference to FIG. 3, the substrate 140 is disposed on the bearing surface 122 of the bearing plate 121 and comprises a plurality of positioning holes 141, the fixing base 120 further includes a plurality of positioning members 124 protruded to the bearing surface 122 of the bearing plate 121, wherein the positioning members 124 are penetrated through the positioning holes 141 to make the substrate 140 disposed at the fixing base 120 accurately. In addition, once the substrate 140 rotates, a conductive wire (not shown in Figs.) electrically connected with the substrate 140 may be broken to lead a broken circuit problem, the substrate 140 can be prevented from rotation by means of the positioning members 124 penetrated through the positioning holes 141 to solve the problem of broken circuit.

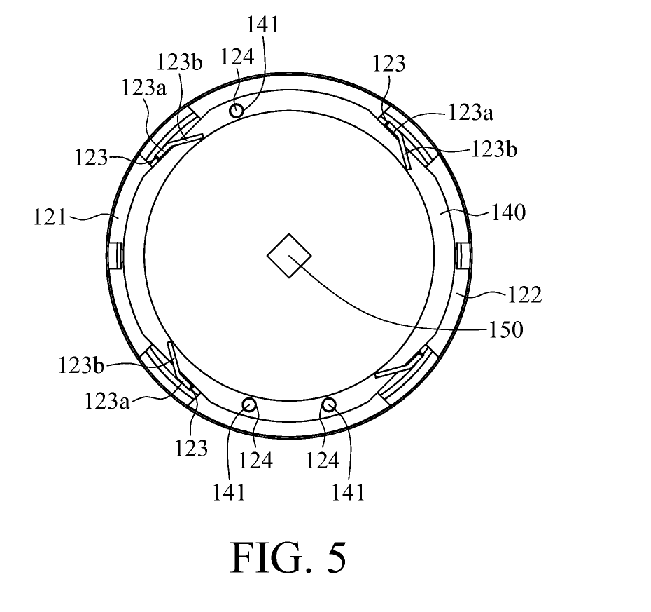

With reference to FIGS. 3, 4 and 5, after disposing the substrate 140 on the bearing surface 122 of the bearing plate 121, the fixing plates 123 are bendable toward the bearing surface 122 of the bearing plate 121 to form a clip space 130 between each of the fixing plates 123 and the bearing surface 122 of the bearing plate 121. The substrate 140 is limited within the clip space 130 and clipped by the bearing plate 121 and the fixing plates 123. Referring to FIG. 3, in this embodiment, the bending portion 123b of each of the fixing plates 123 is bendable toward the bearing surface 122 of the bearing plate 121 to make the bending portions 123b of the fixing plates 123 spaced from the bearing surface 122 of the bearing plate 121, and the substrate 140 is clipped by the bending portion 123b of each of the fixing plates 123 and the bearing plate 121. With reference to FIG. 3 again, in this embodiment, the clip space 130 is composed of the gap 123c of the bending portion 123b and the bearing plate 121. Besides, for the reason that the first interval D1 formed between the front edge 123d and the bearing surface 122 is larger than the second interval D2 formed between the rear edge 123e and the bearing surface 122, the gap 123c may be used for clipping the substrate 140 with different thickness. When a bending angle of the bending portion 123b becomes larger, the substrate 140 can be firmly clipped between the bending portion 123b and the bearing plate 121.

By using mentioned design, the present invention may combine the substrate 140 on the fixing base 120 without utilizing any screws, unlike the way to secure by screws as disclosed in Taiwan patent number M419877, so that a prepared material problem can be solved in the present invention. The speed to bend the bending portion 123b is much faster than that to secure by screws therefore increasing assembly-efficiency.

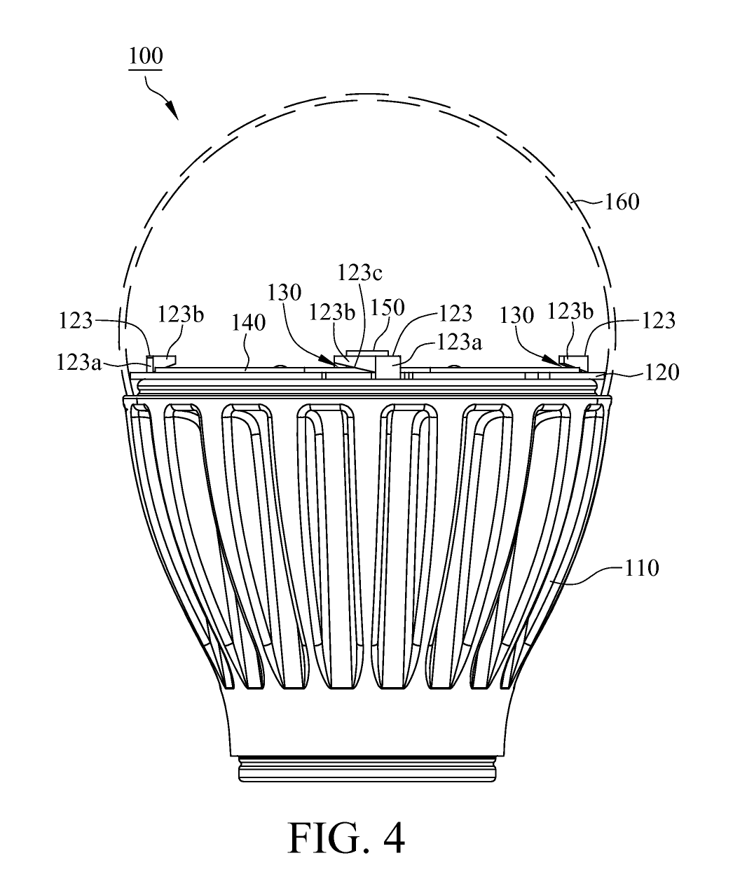

Referring to FIGS. 3 and 4, the fixing base 120 is disposed at the case 110. The lamp cover 160 is coupled to the case 110 and covers the fixing base 120, the substrate 140 and the lighting device 150.

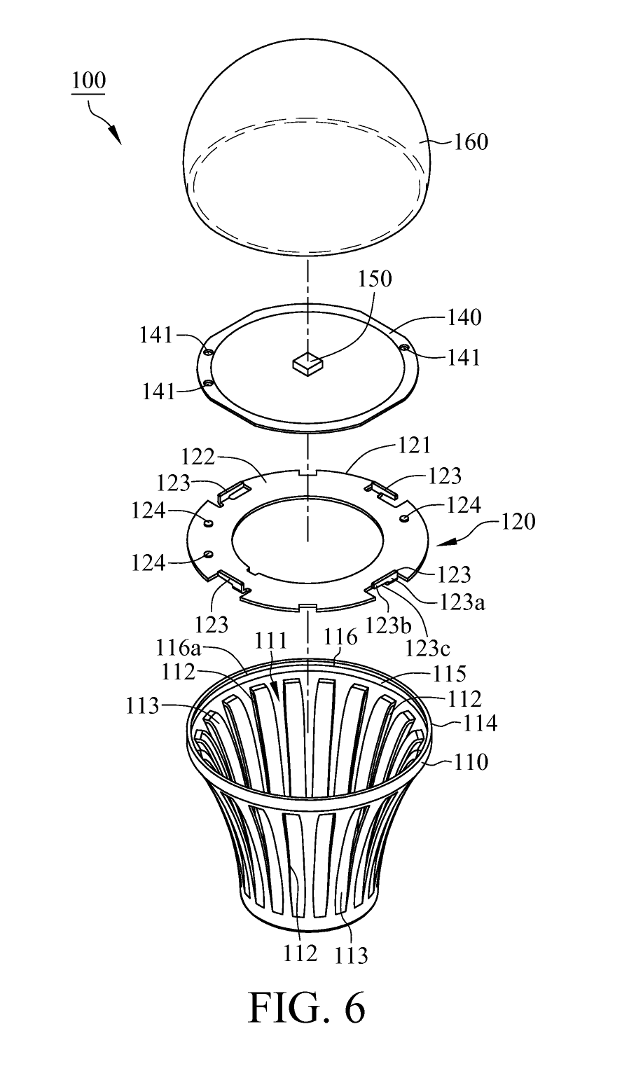

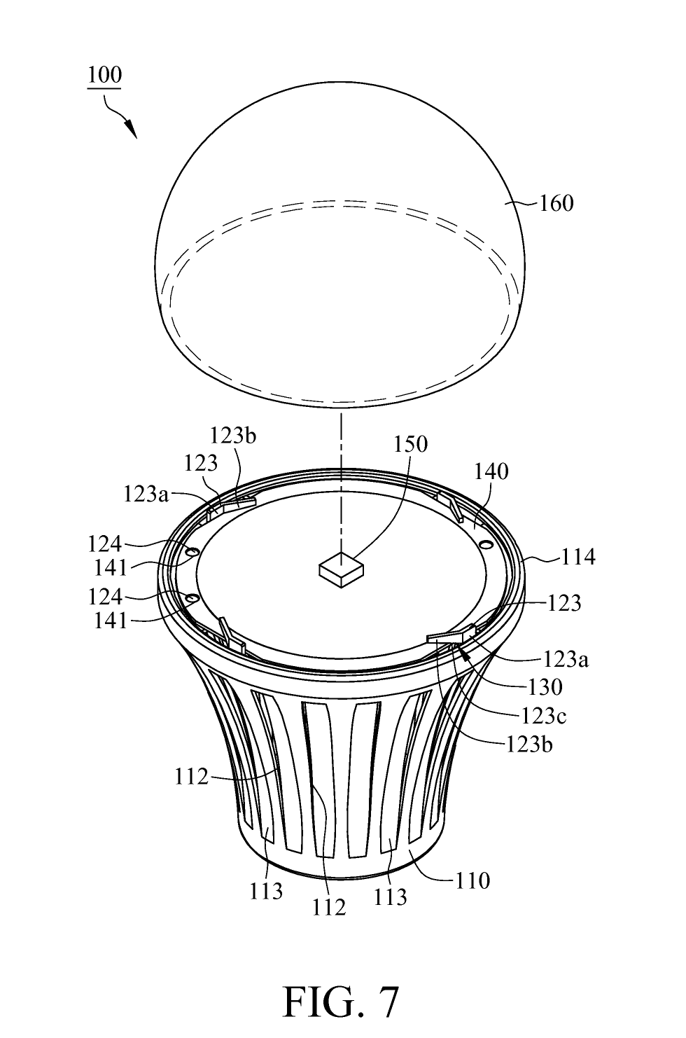

A lighting structure 100 in accordance with a second embodiment of the present invention can be referred to FIGS. 6 and 7. The lighting structure 100 comprises a case 110, a fixing base 120, a substrate 140, a lighting device 150 and a lamp cover 160. The fixing base 120 includes a bearing plate 121 and a plurality of fixing plates 123, the substrate 140 is disposed at a bearing surface 122 of the bearing plate 121, the fixing plates 123 are bendable toward the bearing surface 122 of the bearing plate 121 to make the substrate 140 clipped by the bearing plate 121 and the fixing plates 123.

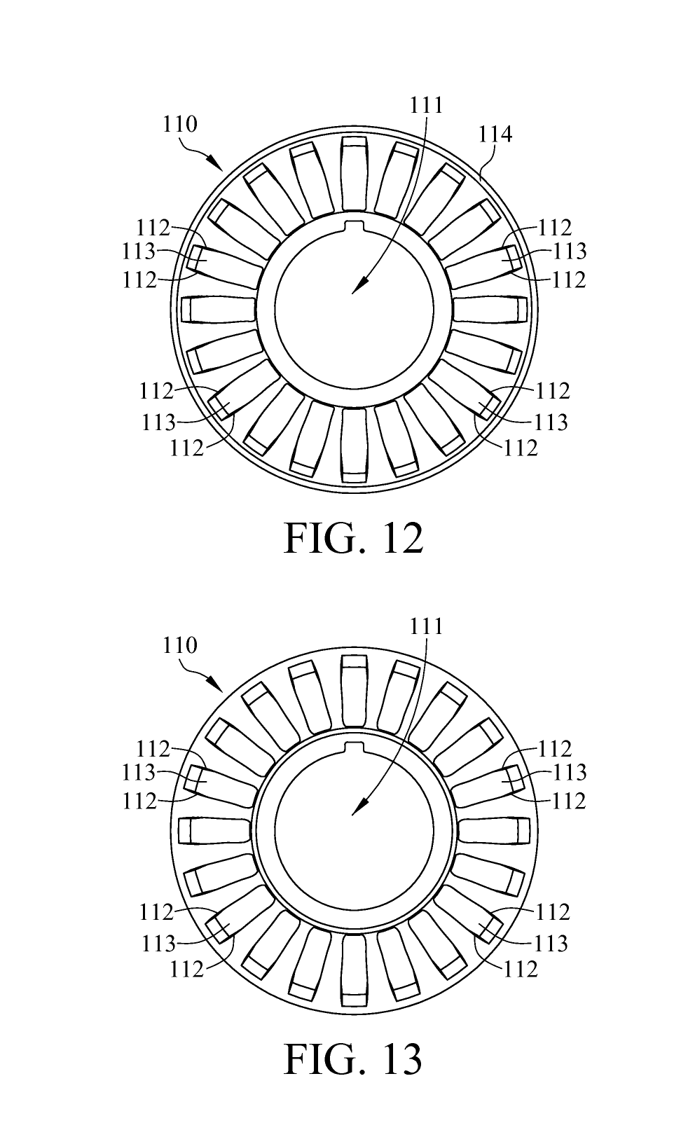

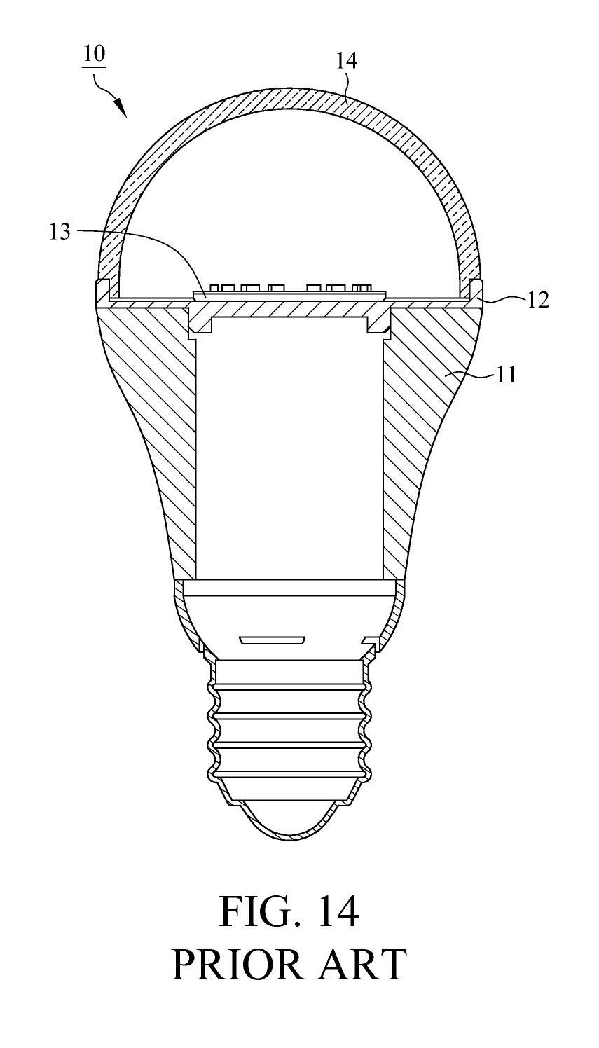

With reference to FIGS. 6, 7, 8, 11, 12 and 13, the difference between the second embodiment and the first embodiment is that the case 110 further comprises an accommodating chamber 111, wherein a plurality of penetration slots 112 and a plurality of ribs 113 of the case 110 are formed by stamping process, the ribs 113 are located in the accommodating chamber 111, and the penetration slots 112 are in communication with the accommodating chamber 111.

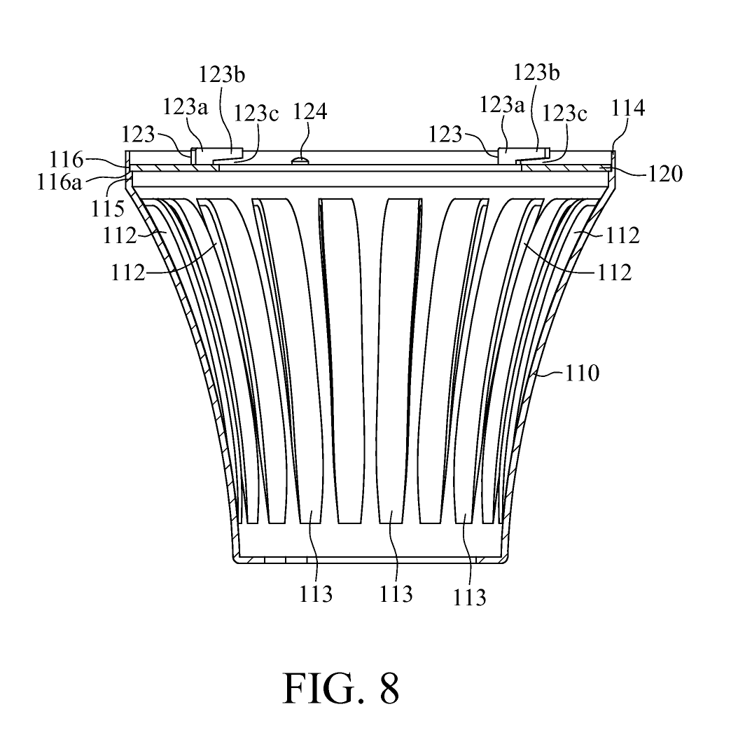

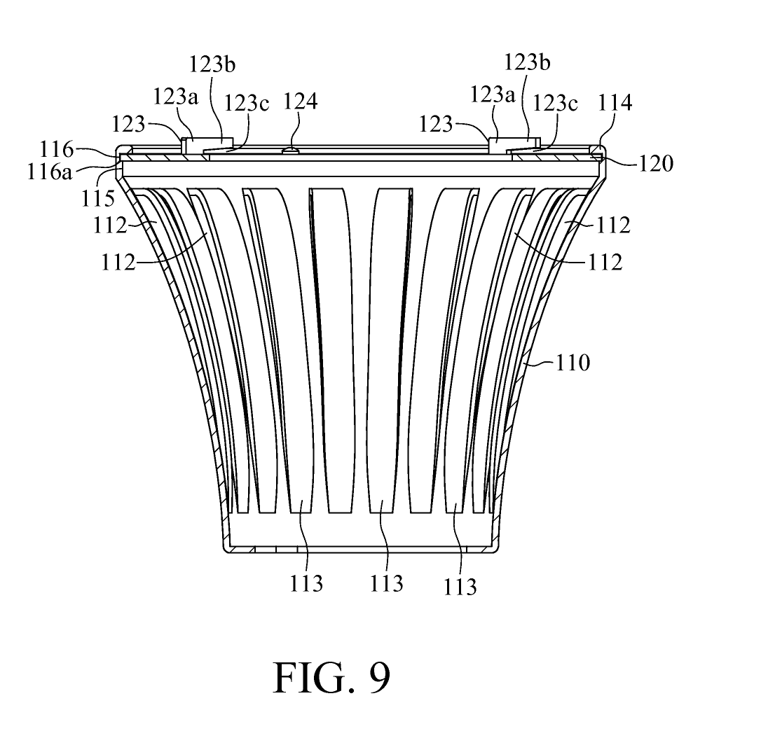

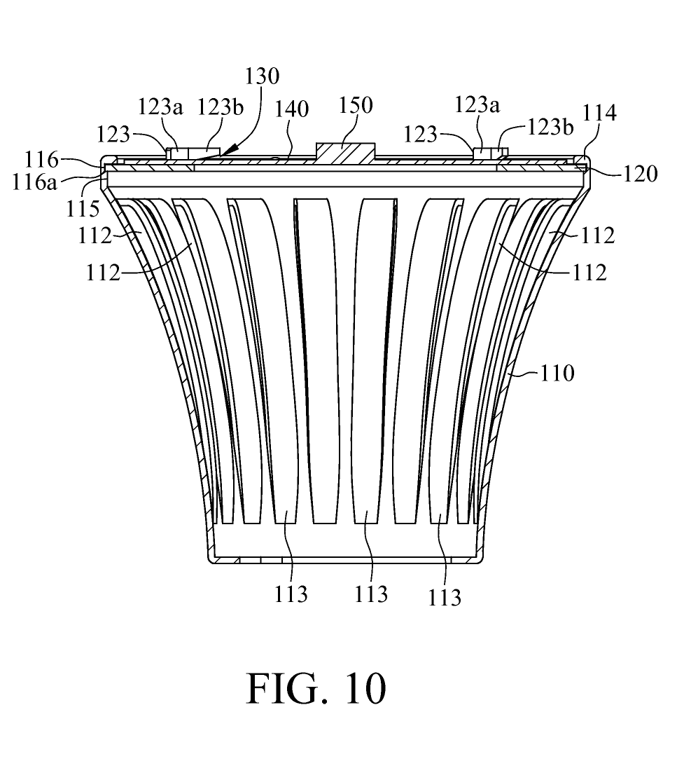

Referring to FIG. 8, in this embodiment, the case 110 further comprises a combining portion 114, an inner lateral surface 115 and a slot 116 recessed from the inner lateral surface 115, wherein the fixing base 120 is disposed at the slot 116. In this embodiment, the slot 116 comprises a supporting surface 116a for bearing the fixing base 120 to be installed at an opening of the case 110. Referring to FIG. 9, the combining portion 114 is bendable toward the accommodating chamber 111 by process of stamping, and then the fixing base 120 is clipped by the combining portion 114 to make the fixing base 120 being fixed at the opening of the case 110. That is to say, the fixing base 120 is clipped between the supporting surface 116a of the slot 116 and the combining portion 114. With reference to FIG. 10, the substrate 140 is disposed at the fixing base 120, and the fixing plates 123 are bendable to make the substrate 140 clipped by the bearing plate 121 and the fixing plates 123.

By using mentioned design, the problem for the fixing base 120 falling off from the opening of the case 110 can be effectively prevented. Accordingly, the substrate 140 and the lighting device 150 disposed on the fixing base 120 may lower the probability to collide with the case 110 or the lamp cover 160 thereby preventing the lighting device 150 from damaging.

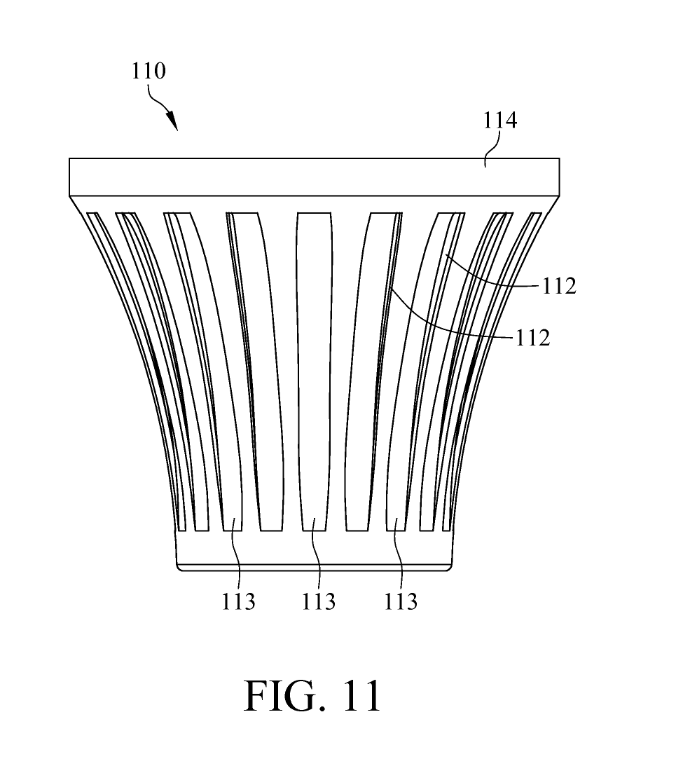

With reference to FIGS. 11 to 13, the structure of the case 110 makes the thermal energy generated from the lighting device 150 not easy to accumulate within the case 110 via design of the penetration slots 112. The penetration slots 112 may rapidly conduct the thermal energy outside the case 110 thereby enhancing heat-dissipation efficiency.

In this invention, the fixing plate 123 of the fixing base 120 is bendable to form the clip space 130 between the fixing plates 123 and the bearing plate 121. The substrate 140 is limited within the clip space 130 and clipped by the bearing plate 121 and the fixing plates 123 to make the substrate 140 being fixed at the fixing base 120. Besides, owning to the reason that the fixing base 120 is firstly disposed at the opening of the case 110, then the combining portion 114 is bendable toward the accommodating chamber 111, and the fixing base 120 is clipped by the combining portion 114. Therefore, the fixing base 120 is firmly fixed at the opening of the case 110.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A lighting structure comprising:
a case;
a fixing base disposed at the case comprising:
a bearing plate having a bearing surface; and
at least one fixing plate coupled to the bearing plate, wherein at least part of the fixing plate is spaced from the bearing surface, and the fixing plate is bendable to form a clip space between the fixing plate and the bearing surface of the bearing plate;
a substrate disposed on the bearing surface of the bearing plate, said substrate is limited within the clip space and clipped by the bearing plate and the fixing plate; and
a lighting device disposed at the substrate.

2. The lighting structure in accordance with claim 1, wherein the fixing plate includes a body portion coupled to the bearing plate and a bending portion spaced from the bearing surface of the bearing plate.

3. The lighting structure in accordance with claim 2, wherein the bending portion comprises a gap.

4. The lighting structure in accordance with claim 3, wherein the gap comprises a front edge and a rear edge, a first interval is formed between the front edge and the bearing surface, a second interval is formed between the rear edge and the bearing surface, and the first interval is larger than the second interval.

5. The lighting structure in accordance with claim 1, wherein the fixing base further includes a plurality of positioning members protruded to the bearing surface of the bearing plate, said substrate comprises a plurality of positioning holes, and the positioning members are penetrated through the positioning holes.

6. The lighting structure in accordance with claim 1, wherein the case comprises an accommodating chamber, a plurality of penetration slots communicating with the accommodating chamber are recessed from the case.

7. The lighting structure in accordance with claim 6, wherein the case further comprises at least one combining portion, said combining portion is bendable toward the accommodating chamber, and the fixing base is clipped by the combining portion.

8. The lighting structure in accordance with claim 1, wherein the case comprises an accommodating chamber and at least one combining portion, the fixing base is disposed at the accommodating chamber, the combining portion is bendable toward the accommodating chamber, and the fixing base is clipped by the combining portion.

9. The lighting structure in accordance with claim 8, wherein the case further comprises an inner lateral surface and a slot recessed from the inner lateral surface, the fixing base is disposed at the slot, the slot comprises a supporting surface, the fixing base is clipped between the supporting surface of the slot and the combining portion.

10. A fixing base of a lighting structure utilized for clipping a substrate of the lighting structure comprising:
a bearing plate having a bearing surface; and
at least one fixing plate coupled to the bearing plate, wherein at least part of the fixing plate is spaced from the bearing surface, and the fixing plate is bendable to form a clip space between the fixing plate and the bearing surface of the bearing plate.

11. The fixing base of a lighting structure in accordance with claim 10, wherein the fixing plate includes a body portion coupled to the bearing plate and a bending portion spaced from the bearing surface of the bearing plate.

12. The fixing base of a lighting structure in accordance with claim 11, wherein the bending portion comprises a gap.

13. The fixing base of a lighting structure in accordance with claim 12, wherein the gap comprises a front edge and a rear edge, a first interval is formed between the front edge and the bearing surface, a second interval is formed between the rear edge and the bearing surface, and the first interval is larger than the second interval.

14. The fixing base of a lighting structure in accordance with claim 10, wherein the fixing base further includes a plurality of positioning members protruded to the bearing surface of the bearing plate, said substrate comprises a plurality of positioning holes, and the positioning members are penetrated through the positioning holes.
